(19) United States
(12) Patent Application Publication
(10) Pub. No.: US 2016/0328669 A1
(43) Pub. Date: Nov. 10, 2016

(54) ON-DEMAND DELIVERY SYSTEM

(71) Applicant: UBER Technologies, Inc., San Francisco, CA (US)

(72) Inventor: Jason Droege, San Francisco, CA (US)

(21) Appl. No.: 14/703,701

(22) Filed: May 4, 2015

(51) Int. Cl. G06Q 10/06; G06Q 10/08

(52) U.S. Cl. CPC G06Q 10/06311; G06Q 10/0832

(57) ABSTRACT

An on-demand delivery system enables users to order and receive inventory items, such as perishable goods and prepared food items. A demand for each inventory item may be forecasted and suppliers may be contacted to prepare inventory items to meet the forecasted demand. Supply vehicles are coordinated to pick up inventory packages and drop-off and transfer the inventory packages to delivery vehicles. During a given service period, requests are received, optimal vehicles are assigned to fulfill such requests, and correlated inventory data for each delivery vehicle are dynamically tracked.

### BACKGROUND

Transportation services are increasingly becoming more diverse and common, particularly with the advance of network services. With the advent of application-based network technologies, various transportation services are becoming more efficient.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example system for providing on-demand goods delivery;

FIG. 2 is a high level flow chart illustrating an example method for providing on-demand goods delivery;

FIG. 3 is a low level flow chart illustrating an example method for providing on-demand goods delivery;

FIG. 4A is a flow chart illustrating an example method for maintaining dynamic log data in connection with on-demand goods delivery;

FIG. 4B is a flow chart illustrating an example method for scheduling delivery vehicles for on-demand goods delivery;

FIGS. 5A-5B illustrate example screenshots of a user interface for selecting on demand delivery services;

FIG. 6 is a block diagram illustrating a mobile computing device upon which examples described herein may be implemented; and

FIG. 7 is a block diagram illustrating a computer system upon which examples described herein may be implemented.

### DETAILED DESCRIPTION

An on-demand delivery system is provided that enables users to order and receive inventory items, such as perishable goods and prepared food items, within minutes of ordering the inventory items. Such an on-demand delivery system, for example, can enable goods to be delivered within a fraction of the time of current delivery systems. The on-demand delivery system can forecast a demand for inventory items and communicate with suppliers to prepare inventory items in order to meet actual demand. Such inventory items may be exceptionally time-sensitive qualitatively (e.g., prepared food items during mealtime) and as such, expedited delivery is desirable in order to deliver such inventory items in a high quality state—which has the added effect of benefiting the requestors of such inventory items. Suppliers can communicate a supply capacity and request amounts of inventory items to prepare for delivery. The on-demand delivery system can coordinate supply vehicles to pick up the inventory items from the suppliers and call delivery vehicles to rendezvous with the supply vehicles in order to receive an inventory of items for delivery to requestors.

The inventory items may be compiled into compositionally identical inventory packages containing the same amount a single inventory item, or same amounts of differing types of inventory items. Since the inventory packages are standardized, the inventory packages can be scanned by the delivery vehicle drivers (e.g., via a radio-frequency identification (RFID) tag or barcode on each inventory package) and the scan data can be received and logged by the on-demand delivery system for each delivery vehicle. Thus, an inventory for each delivery vehicle may be dynamically maintained as requests are received and fulfilled. A pickup location can be transmitted to delivery vehicles, where a rendezvous may take place between the delivery vehicles and the supply vehicles. Such rendezvous may be coordinated by centralized regions, such that one or more supply vehicles can perform drop offs at optimal locations based on the forecasted demand—which itself may be regionally and temporally sensitive.

At any time, requests for individual inventory items may be received by the on-demand delivery system, which can run an optimization technique to identify an optimal delivery vehicle to fulfill the request. Thus, delivery vehicles en route to fulfill requests (e.g., traveling to specified locations to deliver the inventory items) may be dynamically assigned to single or multiple requests based on the delivery vehicle's location, route, traffic data, inventory, and tracking and inventory data of other proximate delivery vehicles. Furthermore, the on-demand delivery system can dynamically schedule delivery vehicles to fulfill multiple requests in real time, and reassign requests to different delivery vehicles dynamically as well.

Among other benefits, examples described herein achieve a technical effect of making on-demand delivery of goods more efficient. The current inefficiencies with delivery systems include preparation time for prepared inventory items, such as prepared food items—where preparation of the item is not initiated until a request is received. Thus, coordinating with suppliers to prepare inventory items based on a forecasted demand for such items largely eliminates the preparation time for such items. Further inefficiencies exist which include site-to-site delivery times. For example, current delivery systems, particularly for prepared food items, involve a single delivery vehicle per item delivered, which transports the requested item from the source to the destination after the item is prepared. Examples described herein can significantly reduce such durations by optimizing drop-off locations and times, and coordinating with delivery vehicles to travel routes that minimize the delivery delta between initial request by a user and delivery.

As used herein, a computing device refer to devices corresponding to desktop computers, cellular devices or smartphones, personal digital assistants (PDAs), laptop computers, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the on-demand delivery system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

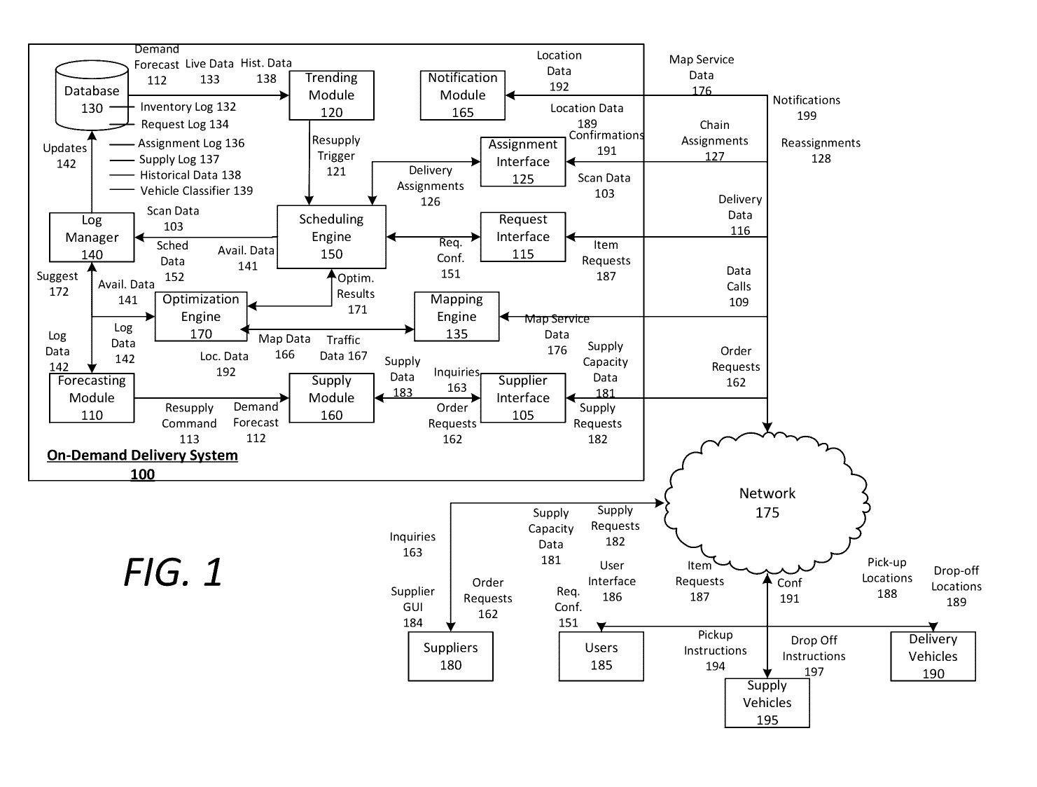

FIG. 1 is a block diagram illustrating an example system for providing on-demand goods delivery. An on-demand delivery system 100 is provided that can arrange goods or items to be distributed in bulk to supply vehicles, and subsequently to delivery vehicles, for purpose of assigning individual delivery vehicles to transport goods to requesting users.

According to an example of FIG. 1, the on-demand delivery system 100 can store historical data 138 in a database 130. In some implementations, the historical data 138 can include historical request data indicating times and/or locations of inventory item requests 187. Such historical data 138 can be compiled, by a log manager 140, with previous data from previous time periods in which the on-demand delivery system 100 enabled on-demand services. The log manager 140 can submit the compiled log data 142 to a forecasting module 110, which can generate a demand forecast 112 for a given region over a given time period. Alternatively, the forecasting module 110 can retrieve the historical data 138 from the database 130 to generate the demand forecast 112.

In various implementations, the forecasting module 110 can identify trends in the log data 142, and perform an analysis of other information, such as demand trends from other services, calendar information, local event data, and the like. For example, the forecasting module 110 may identify a weekday holiday involving high consumption of inventory items, and adjust or increase the demand forecast 112 accordingly. Additionally or alternatively, the forecasting module 110 can scroll local resources to identify various factors that may affect demand for inventory items for a given day. Specifically, the forecasting module 110 may identify a cultural festival (e.g., Cinco de Mayo) on a given day, and thus forecast a higher demand for an inventory item (e.g., prepared Mexican food) associated with the cultural festival.

The forecasting module 110 can generate such demand forecasts 112 for each of a plurality of given regions based on the log data 142 and external resource data. The demand forecasts 112 may also be generated for temporal sensitivity. For example, the forecasting module 110 can identify various points over a given day when demand increases significantly, and construct a time frame with a start time and an end time (e.g., a lunch period) for the on-demand delivery system 100 to provide services. According to some examples, the time frame can be associated with a given region having preferred boundaries, providing constraints for the demand forecast 112 for the given region. Thus, for a given region and time period, the forecasting module 110 can generate a demand forecast 112 that forecasts a demand trends for specified inventory items over the given time period and in the given region.

According to some examples, the demand forecast 112 can be in the form of a time-based trend, such as a graph. Additionally or alternatively, the demand forecast 112 can be in the form of a time-based demand map specifying areas (as well as times) within the given region where demand for specified inventory items is expected to peak. In variations, such demand maps may be generated by the forecasting module for each of a plurality of inventory items. Accordingly, the forecasting module 110 can generate a demand forecast 112 for each inventory item in a menu of inventory items. The demand forecast(s) 112 can be submitted to a supply module 160 of the on-demand delivery system 100 for analysis.

In various examples, the supply module 160 can parse the demand forecast 112 for a given region to determine an optimal amount of each inventory item to fulfill the demand over the given time period. In variations, suppliers 180 can communicate supply capacity data 181 and/or submit supply requests 182 to the on-demand delivery system 100 over a network 175. The supply capacity data 181 can correspond to a maximum or desired amount of a particular inventory item that an individual supplier can prepare for the given time period. The supply requests 182 can be requests or availability calls to the on-demand delivery system 100 for the individual supplier to prepare a certain number of inventory item(s) for the given time period. As a differentiating example, the supply requests 182 can be selected and transmitted by individual suppliers with an implicit or express guarantee that a matching order request will be fulfilled. Thus, a supply request 182 submitted by Restaurant A indicating 1,000 tomato sandwiches, can effectively comprise an option contract that, if accepted, binds Restaurant A to prepare 1,000 tomato sandwiches prior to one or more specific pickup times.

In some implementations, the on-demand delivery system 100 can generate and provide a supplier graphical user interface (GUI) 184 to devices operated by the suppliers 180 (referred to herein as supplier devices) to enable the suppliers 180 to transmit the supply capacity data 181 and the supply requests 182 via user input on the GUI 184. The on-demand delivery system 100 can include a supplier interface 105 to receive the capacity data 181 and supply requests 182. The supplier interface 105 can submit such supply data 183 from the suppliers 180 to the supply module 160, which can perform an optimization technique to determine which suppliers are to prepare which particular inventory items in order to meet the demand forecast 112 for a given region. Thus, the supply module 160 can factor in the availability of the suppliers 180 (as indicated by the supply capacity data 181), the desired supply to be completed by the suppliers 180 (as indicated by the supply requests 182), and the demand forecast 112 for the given region (for any number of inventory items), in order to generate order requests 162 to be submitted to the suppliers 180.

According to some examples, the supply module 160 can also factor in qualitative data for inventory items made by a particular supplier based on user reviews, ratings, rankings, competitions, and the like. Thus, preferred suppliers may be determined by the supply module 160 and prioritized for specified inventory items. For example, a third party review service may indicate that Restaurant A makes the highest quality tomato sandwiches within a given region. Thus, when order requests 162 are generated and submitted to individual suppliers 180 via the network 175, the supply module 160 may prioritize Restaurant A based on the favorable reviews. As an example, the supply module 160 may receive any number of supply requests from different suppliers to prepare tomato sandwiches, but the supply module 160 will generate a specified order request 162 for the tomato sandwiches to be prepared by Restaurant A, based on the prioritization, to fulfill a demand forecast 112 for tomato sandwiches in the given region.

In variations, the supply module 160 can generate inquiries 163, and transmit the inquiries 163 to the suppliers 180 to determine which suppliers 180 are available to fulfill the demand forecast 112. The inquiries 163 can be timed for transmission a predetermined amount of time prior to the start of a service period (e.g., a lunchtime period). Thus, the inquiries 163 can be submitted, for example, a day prior to or the morning of the service period.

In various implementations, the supply module 160 can generate a number of order requests 162 to be transmitted to the suppliers 180 for specified inventory items to fulfill the demand forecast 112 for the given region. The order requests 162 can be transmitted to individual suppliers to prepare any number of individual inventory items. As a rudimentary example, the on-demand delivery system 100 may only offer tomato soup for a lunch period (e.g., between 11:00 am and 2:00 pm) on a given day. Accordingly, the forecasting module 110 can provide a demand forecast 112 for tomato soup for the given region. The supply module 160 can identify whether one or more preferred tomato soup vendors exist, and if so, generate inquiries 163 regarding whether those vendors can provide enough tomato soup to fulfill the demand forecast 112. The order requests 162 can be generated and submitted to the preferred vendors, and other vendors if needed, and supply vehicles 195 may be provided with pickup instructions 194 to pick up the tomato soup items from the vendors.

As a more multifaceted example, the on-demand delivery system 100 may offer several inventory items for delivery. Demand forecasts 112 for such items may instigate the supply module 160 to generate any number of inquiries 163 to potential suppliers 180. Furthermore, supply capacity data 181 and supply requests 182 may be received by the suppliers 180 via the supplier GUI 184. Order requests 162 may be generated for each supplier 180 indicating a number of each type of inventory item a supplier 180 is to prepare for a defined pickup time. In response, the supplier 180 can confirm such order requests 162, which can bind the supplier 180 to an agreement to fulfill the order request 162. Thus, any number of suppliers 180 can be communicated to fulfill order requests 162 based on demand forecasts 112 for any number of inventory items.

According to many examples described herein, the on-demand delivery system 100 can include a scheduling engine 150 that can perform an initial lookup for availability data 141 for supply vehicles 195 to pick up the inventory items. For example, the database 130 can include a vehicle classification list 139, which can identify vehicles as supply vehicles 195 and/or delivery vehicles 190. The vehicle classification list 139 can further provide dynamic availability data 141 to enable the scheduling engine 150 to identify vehicles that are available for the service. Such availability may be triggered by driver selection of a GUI feature displayed on computing devices of the drivers of such vehicles. For example, a driver of a supply vehicle 195 can select an availability feature on the driver's computing device (which can be running a designated application specific to the on-demand delivery service). Accordingly, the log manager 140 can designate that supply vehicle 195 as available in the vehicle classification list 139. Furthermore, location data for that supply vehicle 195 can also be indicated in the vehicle classification list 139. Thus, the scheduling engine 150 can perform an initial lookup in the vehicle classification list 139 for available supply vehicles 195 within a given region to perform pickups of inventory items from the suppliers 180.

The scheduling engine 150 can schedule a single supply vehicle 195 to pick up inventory items per supplier location, or multiple supply vehicles 195 may be coordinated by the scheduling engine 150 to pick up the inventory items from the suppliers 180. In various arrangements, the suppliers 180, operators of the supply vehicles 195, or other entities at a particular drop-off location can compile the inventory items into compositionally identical inventory packages. The scheduling engine can generate and transmit, via an assignment interface 125 pickup instructions 194 to selected available supply vehicles 195 to pick up the inventory items at the respective suppliers 180. Furthermore, the scheduling engine 150 can provide drop-off instructions 197 to the respective supply vehicles 195 to indicate where the supply vehicles 195 are to transfer the inventory items to the delivery vehicles 190. The drop-off instructions 197 can indicate a time and location to drop off the inventory packages, each package including a standard composition of inventory items.

According to many examples, the scheduling engine 150 may further perform a lookup of available delivery vehicles 190 and their respective locations based on state data and/or global positioning system (GPS) data received from respective delivery devices associated with the delivery vehicles 190, and provide a notification 199 indicating the pick-up location 188 where the inventory packages may be transferred from the supply vehicles 195 to the delivery vehicles 190. The standardization of inventory packages may be achieved by the suppliers 180, at the supply vehicles 195, or at the drop-off locations. The inventory packages can be standardized in order to enable the log manager 140 of the on-demand delivery system 100 to keep track of the inventory, in an inventory log 132 of the database 130, for each delivery vehicle 190. Furthermore, the log manager 140 can correlate the order requests 162 to the inventory packages to provide an audit trail to enable accounting of prepared inventory items from the supplier to delivery. For example, the inventory packages may each include a barcode, RFID tag, unique or common identifier, etc. which can be scanned or inputted when a supply vehicle 195 performs the pickup.

In various examples, the transfer from the supply vehicles 195 to the delivery vehicles 190 can also include a scan or input for each transferred inventory package. For example, when a supply vehicle 195 picks up a particular inventory package from a supplier 180, a driver of the supply vehicle 195 can enable a scan feature on the driver's computing device to scan or capture an image, a barcode, or RFID tag on the inventory package. Alternatively, the driver of the supply vehicle 195 can provide input on the designated application indicating the number of inventory packages it received from the supplier 180. Each scan event, comprising scan data 103, can be transmitted automatically to the assignment interface 125 of the on-demand delivery system 100. The scan data 103 can then be submitted to the log manager 140 which can correlate the driver (or supply vehicle 195 of that driver) to the inventory package. Upon transferring the inventory package to a delivery vehicle 190 at a drop-off location, the driver of the delivery vehicle 190 can also enable the scan feature on the driver's device and scan the inventory package. Scan data 103 corresponding to this scan event can be transmitted to the assignment interface 125, and ultimately logged in an inventory log 132 by the log manager. Thus, the log manager 140 can provide updates 142 to the log inventory 132 to indicate that the inventory package has been correlated to the delivery vehicle 190.

As an addition alternative, the supply vehicles 195 may pick up the inventory packages, each composed of a standard composition of inventory items, from the suppliers 180 for direct delivery to requesting users 185, as described in detail below. As yet another alternative, the scheduling engine 150 may assign the delivery vehicles 190 to pick up the inventory packages from the suppliers 180 directly for delivery to requesting users 185.

In certain implementations, once the inventory packages have been transferred from the supply vehicles 195 to the delivery vehicles 190, and the scan data 103 has been received, the scheduling engine 150 can issue delivery assignments 126 to the delivery vehicles 190 based on received inventory items requests 187. The on-demand delivery system 100 can provide a user interface 186 for display on computing devices of users 185, where the user interface offers a menu of inventory items. Individual users 185 can select from such inventory items with, for example, a touch input and confirmation on the user interface 186 to place an order for a particular inventory item (and/or the number of inventory items) and a location where the inventory item is to be delivered (e.g., the user's current location determined from the GPS receiver of the user device or a user-specified delivery location). Such items requests 187 may be received by a request interface 115 of the on-demand delivery system 100 and submitted to the scheduling engine 150. The scheduling engine 150 can automatically generate a request confirmation 151 for transmission back to the requesting user 185.

In many examples, the item request 187 can trigger an optimization engine 170 to run an optimization technique. As an example, the optimization engine 170 can run an algorithm using map data 166 inputs and traffic data 167 inputs based on respective locations of available delivery vehicles 190 and the requesting user's location to determine an optimal delivery vehicle, or a list of optimal delivery vehicles, to fulfill the item request 187. As an addition or alternative, the optimization engine 170 can further account for delivery vehicles 190 current en route to fulfill an item request 187. Thus, in accordance with some examples, the optimization engine 170 can receive availability data 141 from the vehicle classification list 139 to identify available delivery vehicles 190 to fulfill the item request 187. The optimization engine 170 can further perform a lookup in the inventory log 132 to identify matching delivery vehicles 190 that have the requisite inventory to fulfill the item request 187.

In some examples, the on-demand delivery system 100 can include a mapping engine 135 that can generate and transmit data calls 109 over the network 175 to a third-party mapping service. In response, the mapping engine 135 can receive map service data 176 provide live map data 166 and live traffic data 167. These data 166, 167 may be utilized by the optimization engine 170 to determine an optimal delivery vehicle 190, or a list of delivery vehicles, to submit to the scheduling engine 150 for assignment. As an example, the live traffic data 167 may indicate that a delivery vehicle that is closer to a requesting user's location than a second delivery vehicle. However, the optimization engine 170 may determine that the second delivery vehicle is more optimal based on the live traffic data 167, even though the second delivery vehicle is further away.

In variations, the scheduling engine 150 can provide the log manager 140 with availability data 141 indicating delivery vehicles 190 that are currently en route to a respective delivery, or that have yet to be assigned. The log manager 140 can provide such updates 142 to the respective logs, which the log manager 140 dynamically maintains. For example, the log manager 140 can dynamically manage an assignment log 136 providing data regarding which delivery vehicles 190 are assigned to which item requests 187. The log manager 140 may further dynamically manage a request log 134 that can indicate, for example, item requests 187 that have been assigned and fulfilled, item requests 187 that have been assigned and not fulfilled, item requests that have not been assigned, an elapsed time for each request, and the like. As discussed above, the log manager 140 can further dynamically manage the inventory log 132, which can indicate live inventories for each delivery vehicle 190 in each given region.

Thus, in various implementations, the optimization engine 170 can pull log data 142 from any of the dynamic logs in the database 130 (e.g., the inventory log 132, the request log 134, the assignment log 136, and the vehicle classification list 139). Furthermore, based on optimization results 171, the optimization engine 170 can issue suggestions 172 to the log manager 140 to update one or more logs. For example, based on optimization results 171, the optimization engine 170 can submit a suggestion 172 to the log manager 140 to reclassify one or more delivery vehicles 190 as available in order to more efficiently fulfill item requests 187. As another example, the optimization engine 170 can submit a suggestion 172 to the log manager 140 to shuffle the request log 134 to prioritize one or more item requests 187 that may be readily fulfilled by one or more delivery vehicles 190 (available or unavailable). In some examples, the optimization engine 170 may perform an optimization operation for each item request 187. Thus, a received item request 187 can trigger the optimization engine 170 to start an optimization operation based on location data 192 of the requesting user 185. In other examples, the optimization engine 170 can run optimizations periodically based on the request log 134. Thus, in such examples, all such live item requests 187 in the request log 134 can be prioritized and assigned to delivery vehicles 190 periodically in accordance with optimization results 171.

Based on such optimization operations, the optimization engine 170 can submit optimization results 171 to the scheduling engine 150 to enable the scheduling engine 150 to issue optimal delivery assignments 126 to delivery vehicles 190. In some examples, the scheduling engine 150 can issue a single delivery assignment 126 per delivery vehicle 190 per item request 187, and submit scheduling data 152 to the log manager 140 to update the live logs accordingly. In such examples, the scheduling engine 150 can cause all vehicles 190 that are currently en route to a delivery to be classified as unavailable. In variations, the scheduling engine 150 can parse the optimization results 171 to issue chain assignments 127 to specified delivery vehicles 190 in order to fulfill multiple item requests 187 along an identified route. In such examples, the log manager 140 may reclassify certain delivery vehicles 190, or all delivery vehicles 190, as available. Furthermore, the reclassification may take place based on a new item request 187 being received that is proximate to a particular delivery vehicle 190, and/or request traffic—that is, an amount of item requests 187 received versus a number available delivery vehicles 190. Thus, a driver of a delivery vehicle 190 may receive an updated assignment, or a chain assignment 127, to deliver multiple inventory items along a determined route.

In certain implementations, the scheduling engine 150 can parse the optimization results 171 to issue reassignments 128 to delivery vehicles 190. These reassignments 128 can comprise an item request 187, assigned to a first optimal delivery vehicle, being reassigned to a second optimal delivery vehicle based on any number of factors. For example, when the first optimal delivery vehicle is en route to fulfill an item request 187, the scheduling engine 150 may receive a number of additional item requests. Optimization results 171 for these additional item requests may indicate that the first optimal delivery vehicle is proximate to a location to fulfill one or more of the additional item requests. Thus, the scheduling engine 150 may transmit a chain assignment 127 to the first optimal delivery vehicle instructing the driver to make an additional delivery to a requesting user 185 beforehand. This chain assignment 127 can cause the optimization engine 170 to determine that the second delivery vehicle is more optimal than the first. The scheduling engine 150 can issue a reassignment 128 of the initial item request 187 to the second optimal delivery vehicle accordingly.

In several examples, the delivery vehicles 190 and the supply vehicles 195 (e.g., the respective devices of the drivers of those vehicles) can submit confirmations 191 that indicate a commitment to the specified action. Accordingly, the scheduling engine 150 can submit pickup instructions 194 and drop-off instructions 197 to a specified supply vehicle 195. A confirmation 191 received from the specified supply vehicle 195 can indicate that the supply vehicle 195 is committed to perform a pickup of a predetermined amount of inventory items or inventory packages at a specified supplier 180, and drop off the items or packages at a predetermined drop-off location.

Likewise, the scheduling engine 150 can assign, chain assign, or reassign item requests 187 to a specified delivery vehicle 190. A confirmation 191 received from the specified delivery vehicle 190 can bind the driver to fulfill such assignments. Thus, communications between the scheduling engine 150 and a particular delivery vehicle 190 can comprise a pickup location 188 being transmitted to the delivery vehicle 190 indicating a rendezvous with a supply vehicle 195 to pick up a number of inventory packages. The delivery vehicle 190 can transmit a confirmation 191 to the pickup location 188. The scheduling engine 150 may transmit delivery assignments 126 to the delivery vehicles 190 indicating a drop-off location 189 to fulfill a particular item request 187. Accordingly, to accept the delivery assignments 126, the delivery vehicle 190 can transmit a confirmation 191 to deliver a particular inventory item to the drop-off location 189. Such confirmations may bind the driver of the delivery vehicle to perform the designated action.

According to various examples, location data 192 for the supply vehicles 195 and the delivery vehicles 190 can be received by a notification module 165 continuously or periodically. For example, the location data 192 can be received based on GPS resources on the driver devices of such vehicles (e.g., the drivers' mobile computing devices running a designated application). Furthermore, location data 189 for requesting users 185 can also be received continuously or periodically. Based on the location data 192, 189, the notification module 165 can provide notifications 199 to the drivers, suppliers 180, and users 185. For example, the notification module 165 can generate and transmit a notification 199 to a particular supplier 180 to indicate that a supply vehicle 195 is within a certain distance (e.g., within one mile) or time (e.g., within one minute) for the pickup. As another example, the notification module 165 can transmit notifications 199 to delivery vehicles 190 when supply vehicles 195 are within a predetermined distance (e.g., within one mile) or time (e.g., within five minutes) of a drop-off location. As yet another example, the notification module 165 can transmit notifications 199 to requesting users 185 when a responding delivery vehicle 190 is within a predetermined distance or time from a drop-off location (e.g., the requesting user's 185 residence or workplace).

The notification module 165 may be preconfigured to automatically generate and transmit the notifications 199 in accordance with a predetermined protocol. For example, when the on-demand delivery system 100 receives a request 187 for an inventory item from a particular user 185, the notification module 165 can set a geo-fence around the user's location. When a responding delivery vehicle 190 crosses the geo-fence, the notification module 165 can be triggered to automatically generate and transmit a notification 199 to the user 185. The notification 199 can indicate to the user 185 that delivery is imminent. The geo-fence may be a constant radius (i.e., a circle) about the user's location, or may be customized based on a number of factors. For example, the notification module 165 can received map service data 176 from an internal or external mapping resource. The map service data 176 can include traffic data as well as map data. Accordingly, the notification module 165 can customize a geo-fence around the user's 185 location based on, for example, a map layout surrounding the user's 185 location (e.g., speed limits, stop signs, traffic signals, crosswalks, etc.), and/or traffic data indicating estimate time of arrival to the user's 185 location. Thus, a geo-fence may be irregularly shaped on a map, based on a number of factors, or set temporally based on an estimated time of arrival due to traffic conditions. In variations, the notification module 165 may set geo-fences for drop-off locations between supply vehicles 195 and delivery vehicles 190, thus providing a notification 199 to designated delivery vehicles 190 when a supply vehicle 195 crosses the geo-fence. In similar variations, the notification module 165 can set a geo-fence around a supplier 180 to automatically generate and provide the supplier 180 with a notification 199 when a supply vehicle 195 crosses the geo-fence threshold.

During a given time period in which the on-demand delivery service 100 operates, unforeseeable circumstances may arise that conflict with the demand forecast 112 generated by the forecasting module 110. Such occurrences may result in an increase in demand that was not predicted by the forecasting module 110. These unforeseeable circumstances may include, for example, a restaurant being closed down next to an office building, a conference running late, a traffic jam on a local freeway, etc. In accordance with certain implementations, the on demand delivery system 100 can include a trending module 120 that can pull live data 133 from the database 130, such as from the live logs 132, 134, 136, and map such live data 133 to historical data 138. The trending module 120 can further receive the current demand forecasts 112, generated by the forecasting module 110, as an input to dynamically generate demand trends for each given region.

According to examples, the trending module 120 can project whether a current trend for an inventory item will exceed the demand forecast 112 for that inventory item. Such trends may be specific to regions as well as inventory items. Thus, the trending module 120 can identify resupply triggers 121 in the generated trends for inventory items. For example, the live trend for tomato sandwiches (e.g., at 12:30 pm) can indicate that the demand for tomato sandwiches will exceed the supply prepared by Restaurant A beyond a threshold. The threshold may be defined by a current difference between the demand forecast 112 for tomato sandwiches for the given region and the actual demand (i.e., item requests 187 received for tomato sandwiches). Alternatively, the threshold may be defined by a slope divergence in the trend between the demand forecast 112 and the actual demand. Additionally or alternatively, the threshold may be time-dependent, and vary as the time period tolls. As an example, as time progresses, the tolerable level of demand divergence between forecasted and actual demand may decrease, such that a resupply trigger 121 may be instigated more sensitively as time progresses throughout time period.

Upon exceeding the difference amount or slope divergence, the trending module 120 can communicate resupply triggers 121 to the scheduling engine 150 indicating that a particular inventory item is under threat of running out before the time period ends. In response, the scheduling engine 150 can communicate a resupply command 113 to the supply module 160, which can parse through supply capacity data 181 and supply requests 182 to identify suppliers 180 that may be able to fill the projected gap in demand. Additionally or alternatively, the supply module 160 can begin to submit inquiries 163 to potential suppliers 180 that may be able to fill the projected gap in demand. Based on responses from available suppliers, the supply module 160 may submit order requests 162 for those inventory items of which the trending module 120 projects a shortage.

Concurrently, the scheduling engine 150 can reassign supply vehicles 195 or delivery vehicles 190 to make the added pickups. According to some variations, delivery vehicles 190 en route to a delivery but proximate to a supplier 180 may be issued a reassignment 128 to pick up inventory packages comprising the inventory items. New drop-off locations may be communicated to specified delivery vehicles 190 based on, for example, an optimization operation performed by the optimization engine 170. Scan data 103 for the new inventory packages (which themselves may be re-standardized) may be received and logged by the log manager 140, as described herein. Furthermore, the live inventory specific to each delivery vehicle 190 that received added inventory can be updated in the inventory log 132. Still further, item requests 187 for the added inventory item may continue to be received unperturbed. Thus, without significantly disrupting the efficiency of the on-demand service, projected shortfalls in supply of specified inventory items determined by the trending module 120 can be corrected dynamically.

### Methodology

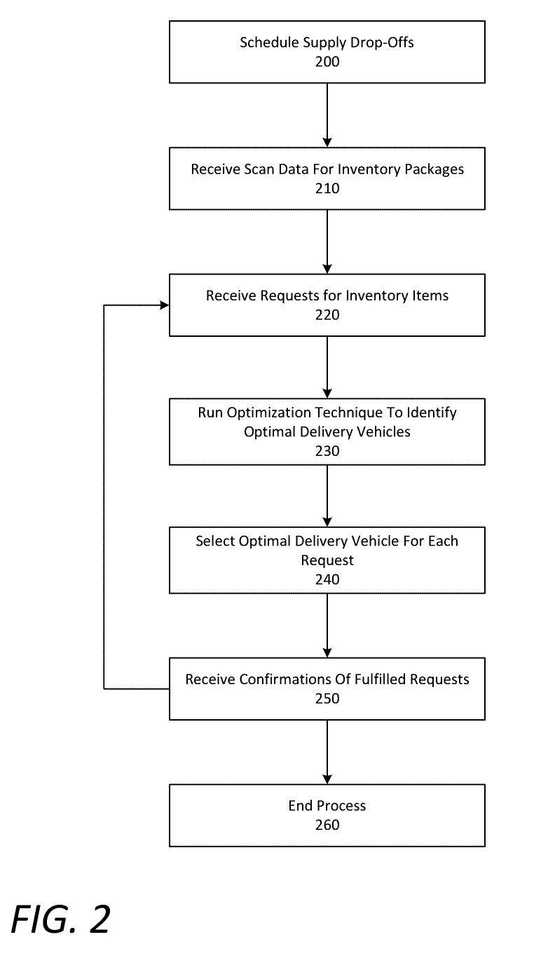

FIG. 2 is a high level flow chart illustrating an example method for providing on-demand goods delivery. In the below description of FIG. 2, reference may be made to like reference characters representing various features of FIG. 1 for illustrative purposes. Furthermore, the high level method described in connection with FIG. 2 may be performed by an example on-demand delivery system 100 as illustrated in FIG. 1. Referring to FIG. 2, the scheduling engine 150 of the on-demand delivery system 100 can schedule a number of supply drop-offs at specified locations within a given region (200). Accordingly, supply vehicles 195 can be coordinated with delivery vehicles 190 by the scheduling engine 150 to rendezvous at optimal locations in order to transfer compositionally matching inventory packages.

In certain implementations, the on-demand delivery system 100 can issue dynamic requests for delivery vehicles 190 to rendezvous with the supply vehicles 195. For example, an initial request beacon may be transmitted to all potential delivery vehicles 190 within a certain radius of a selected drop-off location of a supply vehicle. The supply vehicle for the selected drop-off location may include enough inventory packages for a set number of delivery vehicles (e.g., 20 vehicles). If the confirmation responses to the initial request broadcast fall short of the targeted number of necessary delivery vehicles, the on-demand delivery system 100 can issue one or more additional requests within the same radius or a larger radius of the selected drop-off location.

For example, if 20 delivery vehicles are required for a particular drop-off location, the on-demand delivery system 100 can broadcast an initial request to all potential delivery vehicles 190 within a three mile radius of the drop-off location. Alternatively, the on-demand delivery service 100 may broadcast a request to 20 potential delivery vehicles proximate to the drop-off location. If the confirmation responses fall short of the required number—for example, if only nine confirmation responses a received to the initial request—the on-demand delivery system 100 can broaden the request area (e.g., to a 3.5 mile radius of the drop-off location) and broadcast a subsequent request. Alternatively, the on-demand delivery system 100 can submit a request to a remainder number of required delivery vehicles (e.g., 11 vehicles) required for the drop-off location. Thus, subsequent requests may be broadcasted by the on-demand delivery service 100 until the required number of delivery vehicles (e.g., 20 vehicles) provide confirmation responses.

As the inventory packages are transferred between the supply vehicles 195 and the delivery vehicles 190, each of the inventory packages may be scanned by the drivers of such vehicles. For example, the driver of a delivery vehicle 190 can scan an RFID tag on each received inventory package. Accordingly, the on-demand delivery system 100 can receive scan data 103 corresponding to the number of inventory packages scanned by each delivery vehicle (210). The on-demand delivery system 100 can further receive item requests 187 for individual inventory items (220).

In order to service the requests, the on-demand delivery system 100 can run an optimization technique to identify, based on location data, which delivery vehicle 190 is optimal for fulfilling each of the item requests 187 (230). Based on the results 171 of such optimization operations, the scheduling engine 150 of the on-demand delivery system 100 can select an optimal delivery vehicle 190 to service the item request 187 (240). Accordingly, drivers of the delivery vehicles 190 will not be aware of a particular destination until an item request 187 is assigned to that driver by the scheduling engine 150 (e.g., until an invitation for the item request 187 is transmitted to the delivery device). When a delivery is completed, the on-demand delivery system 100 may receive a confirmation that the item request 187 has been fulfilled (250). This confirmation may be transmitted by the requesting user 185, the driver of the optimal delivery vehicle 190, or upon a scan operation (e.g., RFID or barcode scan) on the inventory item upon delivery.

In accordance with many examples, the process may continue with the on-demand delivery system 100 continuously receiving requests 187 for inventory items (220) and servicing such requests in the manner described. Upon reaching the end of a service period (e.g., a lunch period), the process may end (260).

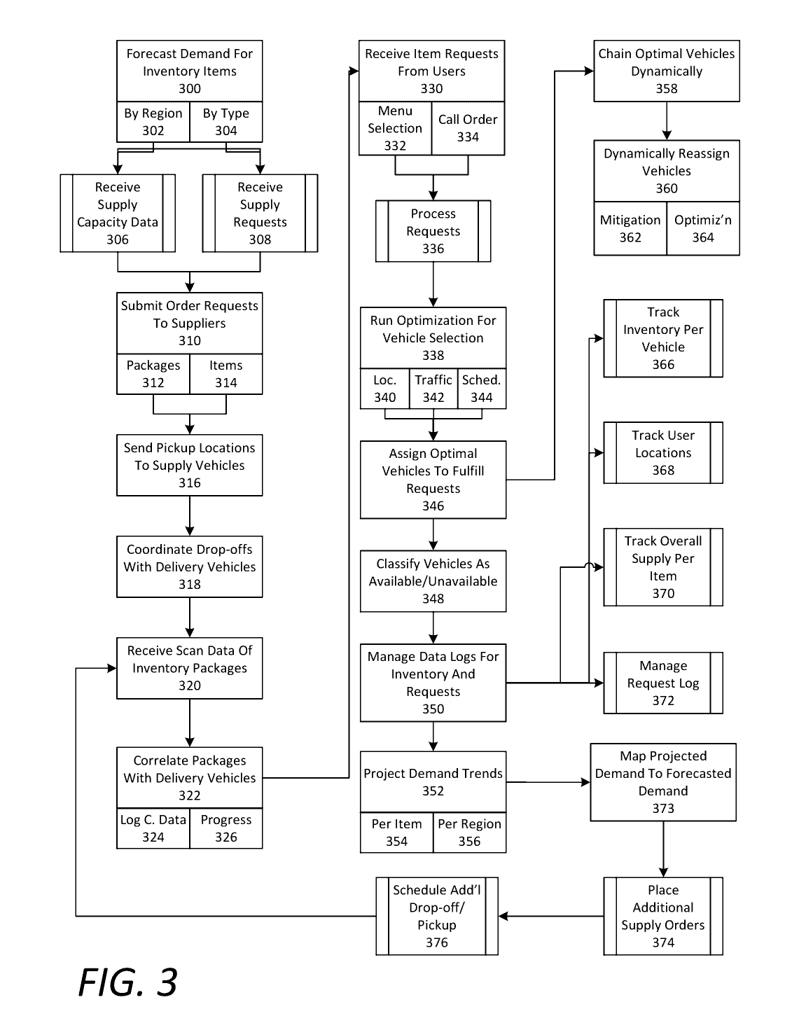

FIG. 3 is a low level flow chart illustrating an example method for providing on-demand goods delivery. In the below description of FIG. 3, reference may be made to like reference characters representing various features of FIG. 1 for illustrative purposes. Furthermore, the low level method described in connection with FIG. 3 may be performed by an example on-demand delivery system 100 as illustrated in FIG. 1. Referring to FIG. 3, a forecasting module 110 of the on-demand delivery system 100 can forecast a demand for specified inventory items (300). The forecasting module 110 can generate such demand forecasts 112 for each of any number of inventory items (e.g., prepared food items, perishable goods, normal goods, services, etc.) (304). The forecasting module 110 can further generated such demand forecasts 112 for specified inventory items within a given region (302). Other factors, such as hour-by-hour or minute-by-minute demand projections for specific areas within the given region, may further be accounted for by the forecasting module 110.

In variations, the supply module 160 of the on-demand delivery system 100 can receive supply capacity data 181 (306) and/or supply requests 182 (308) from potential suppliers 180. Based on such supply data 183 and the demand forecasts 112, the supply module can submit order requests 162 to each of a number of suppliers 180 (310). The order requests 162 may specify that the supplier 180 prepare a specific number of inventory packages, each comprised of a certain amount of inventory items (312). Alternatively, the order requests 162 may simply specify that the supplier 180 prepare a specified number of inventory items (314).

According to many examples, the scheduling engine 150 can submit pickup instructions 194 to supply vehicles 195 (316) indicating the location of one or more suppliers 180. Furthermore, the scheduling engine 150 can coordinate the supply vehicles 195 and the delivery vehicles 190 to rendezvous in order to transfer the inventory items (318). During the transfer between the supply vehicles 195 and the delivery vehicles 190, the on-demand delivery system 100 can receive scan data 103 associated with a total inventory transferred to each delivery vehicle (320). The log manager 140 of the on-demand delivery system 100 can correlate the inventory packages with the delivery vehicles 190 in an inventory log 132 (322). The log manager 140 can log the correlated data in the database 130 for dynamic management as deliveries are made (324). Furthermore, the log manager 140 can track each delivery vehicle's progress through a given time period (326).

The request interface 115 of the on-demand delivery system 100 can receive item requests 187 for specified inventory items from any number of users 185 within a given region (330). Such requests 187 may be received via the network 175 based on a user 185 making a selection of the inventory item from a menu generated on a user interface 186 of the user's computing device (332). Alternatively, the item requests 187 may be received based on a call order made via telephone (334). The on-demand delivery system 100 can then process such requests (336). For example, selection and payment confirmations may be established prior to triggering the scheduling engine 150 to select an optimal vehicle. Alternatively, the received request 187 may automatically trigger the optimization engine 170 to run an optimization technique to identify one or more optimal vehicles to fulfill the item request (338). For automatic trigger-response variations, the scheduling engine 150 may place optimal vehicles on standby until confirmation processing is completed. Otherwise, the optimization engine 170 may transmit optimization results 171 to the scheduling engine 150. The optimization technique may account for such factors as respective locations of delivery vehicles 190 versus the requesting user 185 (340), traffic data 167 (342), and/or current scheduling of available and unavailable delivery vehicles 190 (344).

The scheduling engine 150 can then assign optimal vehicles to the item requests 187 based on the optimization results 171 (346). Based on the number of requests or timing data to fulfill such requests, the log manager 140 can classify each delivery vehicle 190 as available or unavailable (348). In some examples, unavailable vehicles may be omitted from optimization operations by the optimization engine 170. Additionally or alternatively, the optimization engine 170 can utilize locations and inventory of unavailable vehicles when performing optimization operations.

During implementation of on-demand delivery services, the log manager 140 can dynamically manage a number of data logs (350). For example, the log manager 140 can receive scheduling data 152 from the scheduling engine 150 and manage a request log 134 (372) while tracking inventory per delivery vehicle 190 in an inventory log 132 (366). The log manager 140 can further track vehicle and user locations using, for example, a third-party or internal mapping service that utilizes GPS resources of user devices (368). The log manager 140 can further track the overall supply per inventory item by managing a supply log 137 (370).

The trending module 120 of the on-demand delivery system 100 can project actual demand trends (352). During a given service period, the trending module 120 can project demand trends per inventory item (354) and per service region (356). Furthermore, the on-demand delivery system 100 can map a particular demand trend for a given inventory item against demand forecasts generated for the given item (373). If a supply shortage for the given inventory item is projected, the on-demand delivery system 100 can place additional supply orders for the given inventory item (374). Accordingly, the on-demand delivery system 100 can then schedule additional pickups and drop-offs as provided herein (376). The process then continues where scan data 103 of the inventory packages are received during the transfers (320), and inventory packages are correlated with individual delivery vehicles 190 (322).

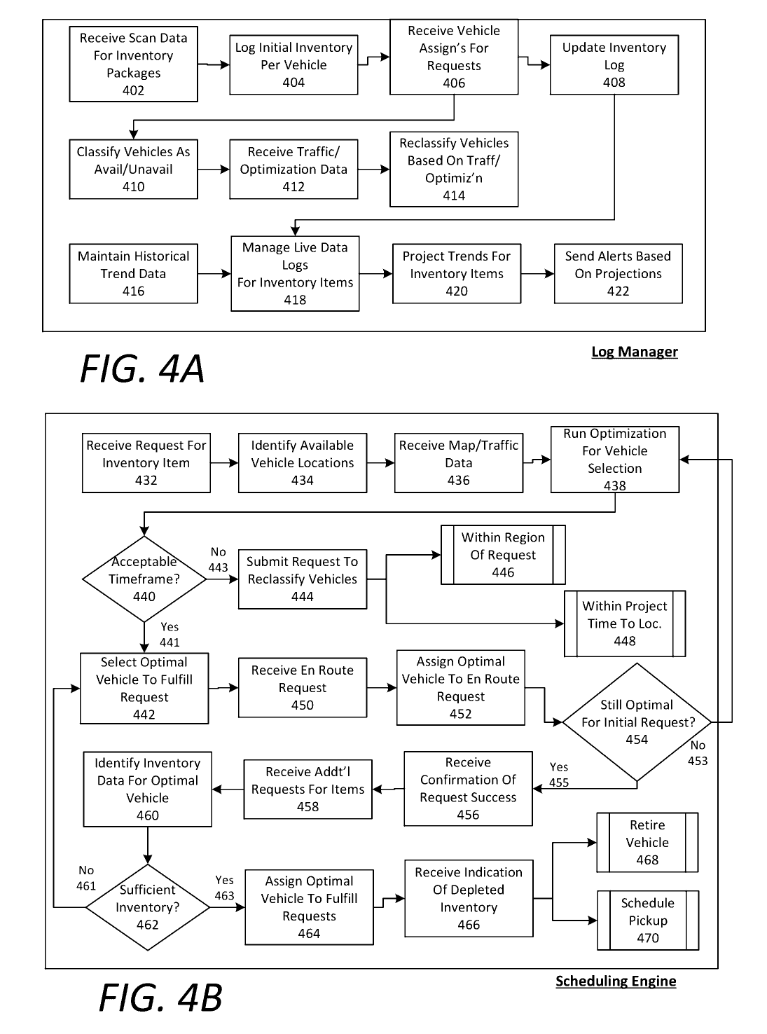

FIG. 4A is a flow chart illustrating an example method for maintaining dynamic log data in connection with on-demand goods delivery. The below process discussed in connection with FIG. 4A may be performed by a log manager 140 of the on-demand delivery system 100 of FIG. 1. Referring to FIG. 4A, the log manager 140 can receive scan data 103 corresponding to individual transfers of inventory packages between supply vehicles 195 and delivery vehicles 190 (402). As discussed herein, each inventory package may be comprised of a standard composition of inventory items. Accordingly, based on the scan data 103, the log manager 140 can log an initial inventory per delivery vehicle in an inventory log 132 (404).

During delivery service operations, the log manager 140 can receive scheduling data 152 corresponding to vehicle delivery assignments 126 to item requests 187 (406). Based on the delivery assignments 126 and item requests 187, the log manager 140 can update the inventory log 132 to decrement specified inventory items for respective delivery vehicles 190 (408). For example, the log manager 140 may determine, based on scan data 103, that a specified delivery vehicle has an initial inventory of 35 tomato sandwiches, among various other inventory items. When an item request 187 is received by a user 185 for one tomato sandwich, and the specified delivery vehicle is assigned, by the scheduling engine 150, to fulfill the request 187, the log manager 140 can decrement the inventory of the specified delivery vehicle by one tomato sandwich. Thus, for tens or even hundreds of delivery vehicles 190 fulfilling item requests 187 in real time, the log manager 140 can dynamically maintain an accurate itemization for each delivery vehicle 190 for each of any number of regions.

Based on a particular delivery vehicle's route and request load (e.g., vehicle A is currently en route to fulfill four item requests 187), the log manager 140 can classify delivery vehicles 190 as either available or unavailable (410). For example, scheduling data 152 may reveal a current time delta of a given delivery vehicle to fulfill a number of item requests 187 as being beyond a given threshold (e.g., 15 minutes). Based on the exceeded threshold, the log manager 140 may classify the given delivery vehicle as unavailable for optimization purposes. However, when a delivery request load exceeds a predetermined threshold (e.g., all time deltas for delivery vehicles 190 within a given region exceeding 10 minutes), the log manager 140 may reclassify one or more unavailable delivery vehicles 190 as available. The log manager 140 may further receive traffic data 167 and optimization data 171 (412), and reclassify delivery vehicles 190 based on such data (414).

Over the course of days, months, even years, the log manager 140 may compile historical data 138 indicating demand trends for inventory items (416). The historical data 138 may be utilized by the forecasting module 110 to project a demand forecast 112 for an upcoming service period. During the service period, the log manager 140 can dynamically manage the live data logs for inventory items per vehicle, item requests, vehicle assignments, overall supply for each inventory item, and vehicle classifications (418). The log manager 140 can provide such data to a trending module 120, which can project supply trends and shortfalls for given inventory items (420). Accordingly, if a shortfall is projected for a given time beyond a certain threshold in a given region (e.g., projected trend for tomato sandwiches in Region X indicates a shortfall of 23 by 12:45 pm), then the log manager 140 can generate and transmit a shortfall alert to the supply module 160 (422).

FIG. 4B is a flow chart illustrating an example method for scheduling delivery vehicles for on-demand goods delivery. The below process discussed in connection with FIG. 4B may be performed by a scheduling engine 150 of the on-demand delivery system 100 of FIG. 1. Referring to FIG. 4B, the scheduling engine 150 can receive item requests 187 for inventory items from any number of requesting users 185 (432). For each received item request 187, the scheduling engine 150 can identify the locations of available delivery vehicles 190 proximate to the location of the requestor (434). The scheduling engine 150 may further receive map data 166 and traffic data 167 within the proximity of the requestor (436).

Based on the map data 166, traffic data 167, and available vehicle locations, the scheduling engine 150 can run an optimization operation to identify an optimal vehicle to handle the request (438). The scheduling engine 150 can then determine whether the optimal vehicle can make the delivery within an acceptable timeframe (e.g., within 10 minutes) (440). If not (443), the scheduling engine 150 may submit a request to the log manager 140 to reclassify unavailable vehicles as available (444). For example, the scheduling engine 150 may request that unavailable delivery vehicles 190 within a given proximity of the requestor be reclassified as available (446). Additionally or alternatively, the scheduling engine 150 may request that unavailable delivery vehicles 190 within a projected time (e.g., based on traffic data 167) be reclassified as available (448). Accordingly, the scheduling engine 150 may run an optimization operation for newly available vehicles to potentially chain requests for a particular delivery vehicle or reassign a given request to a different delivery vehicle in order to service all requests in a most time-efficient manner.

However, if the optimal vehicle identified can fulfill the item request 187 within an acceptable timeframe (441), then the scheduling engine 150 can select the optimal vehicle to fulfill the initial item request 187 (442). While the optimal vehicle is en route to fulfill the initial item request 187, the scheduling engine 150 may receive an additional request while the optimal delivery vehicle is en route (450). Based on an optimization operation, the scheduling engine 150 may determine that the optimal vehicle is also optimal to fulfill the additional, en route request. Thus, the scheduling engine 150 can issue a chain assignment 127 to the optimal vehicle to fulfill the en route request prior to fulfilling the initial request (452).

The scheduling engine 150 may then determine whether the optimal vehicle is still optimal for the initial request based on, for example, traffic data and a delay caused by fulfillment of the en route request (454). If not (453), the scheduling engine 150 may run an additional optimization operation for proximate vehicles to identify and select a more optimal delivery vehicle. Thus, the scheduling engine 150 may issue a reassignment 128 of the initial request to the more optimal vehicle, and cancel the initial request for the current vehicle. However, if the current optimal vehicle is still optimal to fulfill the initial request (455), then the scheduling engine 150 can await for confirmation of delivery success (456).

Over the course of the service period, the scheduling engine 150 can receive additional requests 187 for specified inventory items (458). If a new item request is close to the optimal delivery vehicle (e.g., within a quarter of a mile), the scheduling engine 150 can perform a lookup in a live inventory log 132 of the database 30 to identify inventory data for the current optimal vehicle to determine whether the current optimal vehicle can fulfill the new item request (460). Accordingly, the scheduling engine 150 can (i) identify that a proximity of the new request is within a predetermined threshold distance (e.g., a quarter of a mile) of the current optimal vehicle, (ii) without performing an additional optimization operation, perform a lookup to determine whether the current optimal delivery vehicle has sufficient inventory to fulfill the new request, and (iii) if so (462), automatically assign the current optimal delivery vehicle to fulfill the request (464). However, if the current optimal vehicle is determined not to have sufficient inventory to fulfill the new request (461), the scheduling engine 150 can perform an additional optimization operation for the new request and select a new optimal vehicle to fulfill the request (442).

During the service period, the scheduling engine 150 can receive an indication that a delivery vehicle has a depleted inventory (466). Accordingly, the scheduling engine 150 can either flag the delivery vehicle as available for resupplying. Accordingly, if an additional supply is scheduled for preparation, the scheduling engine 150 may assign the delivery vehicle to pick up new inventory packages from a supplier, or rendezvous with a supply vehicle at a drop-off location to pick up additional inventory (470). However, if the service period is within a threshold of expiration (e.g., within 20-30 minutes), the scheduling engine 150 may simply retire the delivery vehicle for that service period (468).

The system descriptions and processes provided above are provided by way of example, and not by way of limitation. The goods discussed for on-demand delivery above may be qualitatively time-sensitive items, such as prepared food items. However, the above descriptions may be implemented for any goods in which dynamic inventory management and vehicle scheduling may be desired. As such, the disclosure herein may be implemented with current delivery systems for non-perishable goods where inventory items may be compiled into standardized inventory packages and placed in the care of individual users or delivery vehicles. Thus, inventory correlations may be maintained over extended periods until all inventory items have been requested, delivered, and thus depleted.

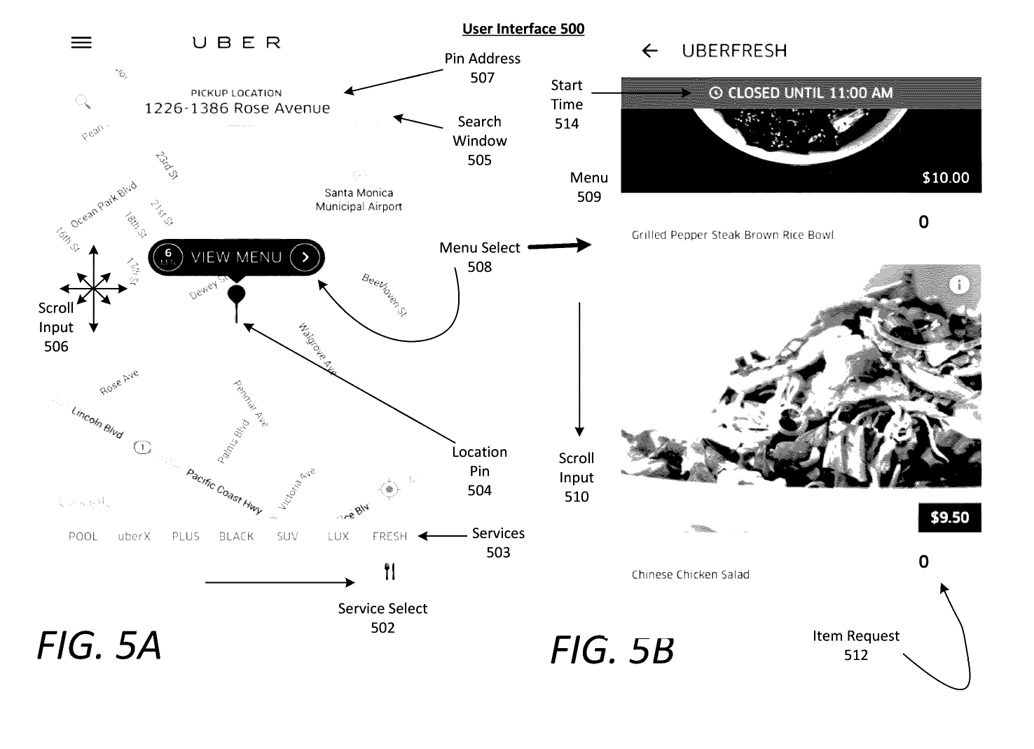

FIGS. 5A-5B illustrate example screenshots of a user interface for selecting on demand delivery services. In the example shown in FIG. 5A, a user interface 500 is provided that includes a scrollable map. The user interface 500 may be generated in response to a user selection of a service application residing on, for example, the user's mobile computing device. In many examples, the user is enabled to enter inputs and gestures to interact with the map. Such inputs and gestures can include pinch gestures to zoom in and zoom out, and drag or scroll inputs 506 to scroll the map in any number of directions. A location pin 504 is provided to set a location of the user. In some examples, when the map remains static for a predetermined duration, available services 503 can pop up based on the position of the location pin 504 on the map. Additionally or as an alternative, a search window 505 can be included that enables the user to enter a particular address or location, which can cause the user interface to automatically set the location pin 504 on the map at the entered address or location.

In various implementations, a service selection feature 502 is included to enable the user to select from various services 503 provided based on the position of the location pin 504 on the map. By scrolling the service selection feature 502 proximate to a particular service, the application can generate a designated response on the map. In one example, placing the service selection feature proximate to the “uberX” service can cause the application to generate location identifiers of the nearest available drivers and a time indicator providing a time delta for pickup. As another example, a selection of the “FRESH” service, as shown in FIG. 5A, can result in a menu selection feature 508 being displayed on the map. In some variations, the menu selection feature 508 can also include an estimated time of delivery for one or more menu items (i.e., inventory items).

A user input on the menu selection feature 508 can cause a scrollable menu 509 to be generated on the display, as shown in FIG. 5B. Referring to FIG. 5B, the scrollable menu 509 can have any number of items available based on the position of the location pin 504 on the map of FIG. 5A. For example, the location pin 504 may be within a service region inexorably tied to the scrollable menu 509. Accordingly, food items from local restaurants and eateries (i.e., local suppliers) may be listed on the scrollable menu 509 that are not available in other regions.

A scroll input 510 on the scrollable menu 509 allows the user to view the available menu items. In many examples, the on-demand delivery service is time sensitive in accordance with food preparation for mealtimes, and the coordination of supply vehicle pickups and drop-offs. In such examples, the on-demand service may only be provided at certain times of the day, such as during mealtimes. Accordingly, the user interface 500 can include a start time 514 or a time window for the on-demand service which corresponds to a particular mealtime, such as lunch or dinner.

In variations, each menu item on the scrollable menu 509 can include an item request feature 512 which can enable the user to select a particular menu item. In some examples, the item request feature 512 can enable the user to select any number of a particular menu item, or multiple menu items. Upon selecting a desired menu item, the user can submit the item request, which can trigger the on-demand delivery system to find an optimal delivery vehicle with the desired menu item in its inventory, and assign the optimal delivery vehicle to fulfill the item request.

### Hardware Diagrams

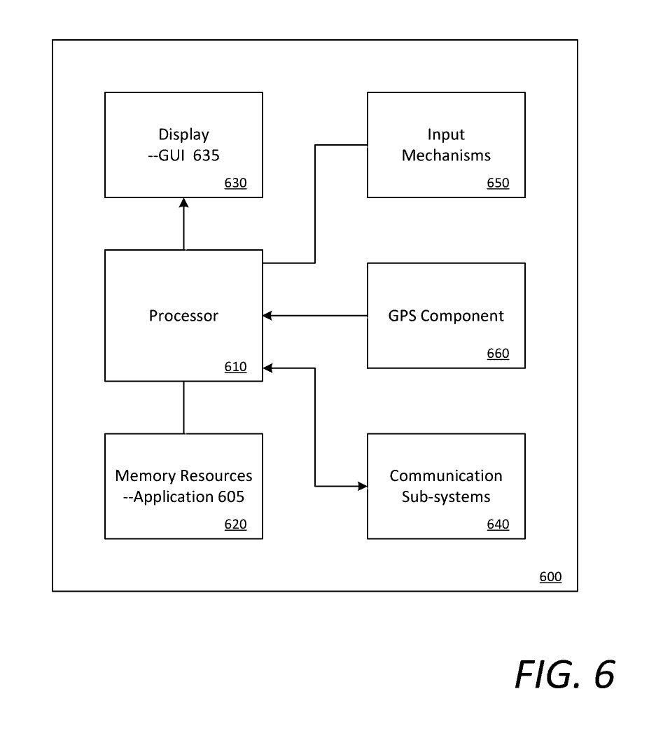

FIG. 6 is a block diagram that illustrates a mobile computing device upon which examples described herein may be implemented. In one example, a mobile computing device 600 may correspond to, for example, a cellular communication device (e.g., feature phone, smartphone etc.) that is capable of telephony, messaging, and/or data services. In variations, the mobile computing device 600 can correspond to, for example, a tablet or wearable computing device. Still further, the mobile computing device 600 can be distributed amongst multiple portable devices of drivers (of supply vehicles or delivery vehicles), suppliers, and requesting users.

In an example of FIG. 6, the computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component) 660. In one example, at least one of the communication sub-systems 640 sends and receives cellular data over data channels and voice channels.

A delivery driver can operate the mobile computing device 600 when on a shift to provide, for example, on-demand delivery services. The memory resources 620 can store one or more applications 605 for linking the mobile computing device 600 with a network service that enables or otherwise facilitates delivery services between suppliers, drivers, and requesting users. Execution of the application 605 by the processor 610 may cause a specified graphical user interface (GUI) 635 to be generated on the display 630. Interaction with a supplier GUI 635 can enable suppliers to submit supply data and receive order requests and confirmations from the on-demand delivery system. Furthermore, Interaction with a driver GUI can enable drivers of supply and delivery vehicles to receive assignments to fulfill item requests or perform a pickup and/or drop-off. Further still, interaction with a requestor GUI can enable requesting users to browse and select inventory items from a generated inventory menu for on-demand delivery.

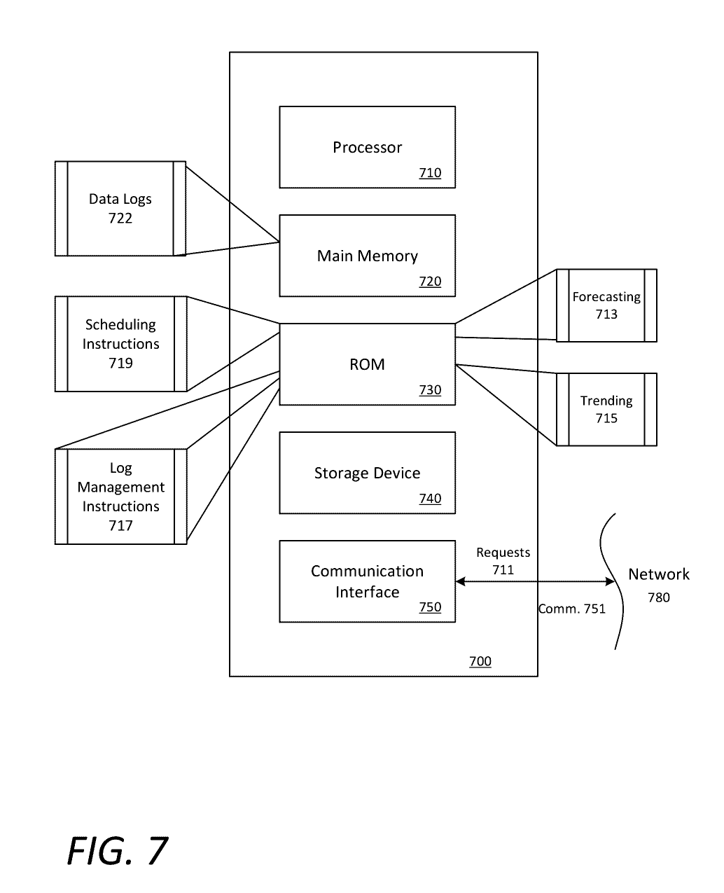

FIG. 7 is a block diagram that illustrates a computer system upon which examples described herein may be implemented. A computer system 700 can be implemented on, for example, a server or combination of servers. For example, the computer system 700 may be implemented as part of a network service for providing transportation and on-demand delivery services. In the context of FIG. 1, the on-demand delivery system 100 may be implemented using a computer system such as described by FIG. 7. The on-demand delivery system 100 may also be implemented using a combination of multiple computer systems as described in connection with FIG. 7.

In one implementation, the computer system 700 includes processing resources 710, a main memory 720, a read-only memory (ROM) 730, a storage device 740, and a communication interface 750. The computer system 700 includes at least one processor 710 for processing information stored in the main memory 720, such as provided by a random access memory (RAM) or other dynamic storage device, for storing information and instructions which are executable by the processor 710. The main memory 720 also may be used for storing temporary variables or other intermediate information during execution of instructions to be executed by the processor 710. The computer system 700 may also include the ROM 730 or other static storage device for storing static information and instructions for the processor 710. A storage device 740, such as a magnetic disk or optical disk, is provided for storing information and instructions.

The communication interface 750 enables the computer system 700 to communicate with one or more networks 780 (e.g., cellular network) through use of the network link (wireless or a wire). Using the network link, the computer system 700 can communicate with one or more computing devices, and one or more servers. In accordance with examples, the computer system 700 receives item requests 711 from the mobile computing device of individual users. The executable instructions stored in the memory 730 can include scheduling instructions 719, which the processor 710 executes to schedule supply pickups and drop-offs, and delivery vehicle assignments to fulfill item requests. The executable instructions stored in the memory 730 can also include log management instructions 717, which enable dynamic tracking of inventory, vehicles, requests, assignments, and the like. The executable instructions stored in the memory 730 can also include forecasting instructions 713 to generate demand forecasts for inventory items in a given region. The memory can further store trending instructions 715 to project live trends for inventory items during a given service period. The memory 730 can include data logs 722 that can be managed dynamically during the service period and enable scheduling of vehicles and trending of inventory items. By way of example, the instructions and data stored in the memory 730 can be executed by the processor 710 to implement an example on-demand delivery system 100 of FIG. 1. In performing the operations, the processor 710 can generate and send scheduling communications 751 via the communication interface 750 to the mobile computing device 600 of the driver.

The processor 710 is configured with software and/or other logic to perform one or more processes, steps and other functions described with implementations, such as described by FIGS. 1-4, and elsewhere in the present application.

Examples described herein are related to the use of the computer system 700 for implementing the techniques described herein. According to one example, those techniques are performed by the computer system 700 in response to the processor 710 executing one or more sequences of one or more instructions contained in the main memory 720. Such instructions may be read into the main memory 720 from another machine-readable medium, such as the storage device 740. Execution of the sequences of instructions contained in the main memory 720 causes the processor 710 to perform the process steps described herein. In alternative implementations, hard-wired circuitry may be used in place of or in combination with software instructions to implement examples described herein. Thus, the examples described are not limited to any specific combination of hardware circuitry and software.

While examples of FIG. 6 and FIG. 7 provide for a mobile computing device 600 and a computer system 700 for implementing aspects described, in some variations, the mobile computing device 600 can operate to implement some or all of the functionality described with the on-demand delivery system 100.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the invention is not limited to those precise examples. As such, many modifications and variations will be apparent to practitioners skilled in this art. Accordingly, it is intended that the scope of the invention be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

What is claimed is:

1. A system comprising:
one or more processors; and
one or more memory resources storing instructions that, when executed by the one or more processors, cause the system to:
schedule a plurality of supply drop-offs of inventory packages by respective supply vehicles at a plurality of drop-off locations;
for each of the plurality of supply-drop offs, receive data corresponding to a plurality of inventory package transfers between the respective supply vehicles and a plurality of delivery vehicles, each inventory package comprising a plurality of inventory items;
receive, from a user device, an initial request for one or more of the plurality of inventory items from a requesting user at a specified location; and
in response to the initial request, assign an optimal one of the plurality of delivery vehicles to fulfill the initial request.

2. The system of claim 1, wherein the executed instructions cause the system to assign the optimal delivery vehicle to fulfill the initial request by (i) identifying respective locations of available delivery vehicles from the plurality of delivery vehicles, and (ii) selecting the optimal delivery vehicle based on a timing optimization between the specified location of the requesting user and the respective locations of the available delivery vehicles.

3. The system of claim 2, wherein the available delivery vehicles comprise drivers currently not fulfilling requests for inventory items.

4. The system of claim 3, wherein the available delivery vehicles further comprise drivers currently fulfilling one or more other requests for inventory items, and wherein the timing optimization further accounts for timing data corresponding to the one or more other requests.

5. The system of claim 4, wherein the instructions, when executed by the one or more processors, further cause the system to:
while the optimal delivery vehicle is traveling along a route to fulfill the initial request, receive a number of additional requests for inventory items from other user devices, the number of additional requests specifying a number of respective locations near the route;
based on the timing optimization, determine that the optimal delivery vehicle is most optimal to fulfill the number of additional requests; and
assign the optimal delivery vehicle to fulfill the number of additional requests.

6. The system of claim 5, wherein the instructions, when executed by the one or more processors, further cause the system to:
while the optimal vehicle is en route to fulfill the number of additional requests, determine, based on the timing optimization, that a second delivery vehicle is more optimal to fulfill the initial request than the optimal delivery vehicle; and
transfer the initial request from the optimal delivery vehicle to the second delivery vehicle.

7. The system of claim 2, wherein the timing optimization further accounts for traffic conditions for each of the available delivery vehicles.

8. The system of claim 2, wherein the instructions, when executed by the one or more processors, further cause the system to:
in response to assigning the optimal vehicle to fulfill the initial request, classifying the optimal delivery vehicle as an unavailable delivery vehicle; and
when the optimal delivery vehicle is within a predetermined distance or time from fulfilling the initial request, reclassifying the optimal delivery vehicle as one of the available delivery vehicles.

9. The system of claim 1, wherein the instructions, when executed by the one or more processors, further cause the system to:
prior to scheduling the plurality of supply drop-offs, (i) forecast a demand for the inventory items for a given time period over a given geographic region, (ii) place a number of orders for the inventory packages to one or more suppliers based on the forecasted demand, and (iii) communicate pick-up times to each respective supply vehicle to pick up the inventory packages from the one or more suppliers.

10. The system of claim 9, wherein the instructions, when executed by the one or more processors, further cause the system to:
during the given time period, dynamically generate a number of trends corresponding to requests for the inventory items within the given geographic region; and
based on a projection of one or more of the trends exceeding the forecasted demand, place one or more additional orders for inventory packages to at least one of the one or more suppliers.

11. The system of claim 10, wherein the instructions, when executed by the one or more processors, further cause the system to:
schedule an additional supply drop-off of the additional inventory packages for the given geographic region within the given time period.

12. The system of claim 1, wherein receiving the data comprises, for each respective one of the plurality of delivery vehicles, (i) receiving individual scan data for each of the inventory packages by a delivery device corresponding the respective delivery vehicle, and (ii) correlating the respective delivery vehicle to a total number of inventory items.

13. The system of claim 12, wherein each of the plurality of inventory packages comprises a radio-frequency identification (RFID) tag, and wherein each of the individual scan data corresponds to a scan, by the delivery device, of the RFID tag on the inventory package.

14. The system of claim 12, wherein the instructions, when executed by the one or more processors, further cause the system to:
maintain a dynamic inventory for each respective delivery vehicle, the dynamic inventory comprising a dynamic correlation between the respective delivery vehicle and the total number of inventory items.

15. The system of claim 14, wherein maintaining the dynamic inventory for each respective delivery vehicle comprises, in response to assigning the respective vehicle to fulfill a number of requests, decrementing the total number of inventory items for the respective delivery vehicle based on a number of inventory items requested in each of the number of requests.

16. The system of claim 14, wherein maintaining the dynamic inventory for each respective delivery vehicle comprises, decrementing the total number of inventory items for the respective delivery vehicle in response to individual confirmations from the delivery device, each of the individual confirmations corresponding to the delivery device indicating a successful delivery of a number of inventory items.

17. The system of claim 1, wherein each of the inventory packages comprises a standard composition of inventory items.

18. The system of claim 1, wherein each of the plurality of inventory items comprises a prepared food item.

19. A method of fulfilling on-demand delivery requests, the method performed by one or more processors of an on-demand delivery system and comprising:
scheduling a plurality of supply drop-offs of inventory packages by respective supply vehicles at a plurality of drop-off locations;
for each of the plurality of supply-drop offs, receiving scan data corresponding to a plurality of inventory package transfers between the respective supply vehicles and a plurality of delivery vehicles, each inventory package comprising a plurality of inventory items;
receiving, from a user device, an initial request for one or more of the plurality of inventory items from a requesting user at a specified location; and
in response to the initial request, assigning an optimal one of the plurality of delivery vehicles to fulfill the initial request.

20. A non-transitory computer readable medium storing instructions for fulfilling on-demand delivery requests, wherein the instructions, when executed by one or more processors of an on-demand delivery system, cause the on-demand delivery system to:
schedule a plurality of supply drop-offs of inventory packages by respective supply vehicles at a plurality of drop-off locations;
for each of the plurality of supply-drop offs, receive scan data corresponding to a plurality of inventory package transfers between the respective supply vehicles and a plurality of delivery vehicles, each inventory package comprising a plurality of inventory items;
receive, from a user device, an initial request for one or more of the plurality of inventory items from a requesting user at a specified location; and
in response to the initial request, assign an optimal one of the plurality of delivery vehicles to fulfill the initial request.
